(19) United States
(12) Patent Application Publication
(10) Pub. No.: US 2010/0280426 A1
(43) Pub. Date: Nov. 4, 2010

(54) MASSAGE DEVICE

(76) Inventor: Ming-Wei TSAI, Wugu Township (TW)

Correspondence Address: BIRCH STEWART KOLASCH & BIRCH, PO BOX 747, FALLS CHURCH, VA, 22040-0747, US

(21) Appl. No.: 12/434,295

(22) Filed: May 1, 2009

(51) Int. Cl. A61H 7/00

(52) U.S. Cl. 601/99; 601/134

(57) ABSTRACT

A massage device includes a housing in which is assembled an actuating mechanism including a worm shaft and worm gears. The massage device includes at least one massage unit mounted through the housing and driven by the actuating mechanism. The massage unit includes a driving gear and a plurality of driven gears engaged with the driving gear to form a set of planetary gears. A top of each driven gear is provided with a plurality of mounting seats of different heights, and a massage member is disposed on each of the mounting seats. As multiple massage members are provided at different positions and heights, a massage action comprised of pressing and kneading movements can be produced on a region of a user's body put in contact with the massage members.

### BACKGROUND OF THE INVENTION

1. Field of the Invention

The present invention generally relates to massage devices, and more particularly to a massage device that uses a worm shaft and worm gears as actuating mechanism to drive a set of planetary gears for operating a massage unit.

2. The Prior Arts

Taiwanese Patent Publication Nos. 238543 and 435223 disclose a conventional massage device with an actuating mechanism that performs rotary massage actions along two circular paths. Such a mechanism uses a worm shaft to drive two opposite worm gears in opposite rotation. Accordingly, the kneading elements mounted eccentrically on the worm gears perform rotating movements along the circular paths to produce a massage action. So far, the aforementioned construction and operating movement may be disposed in the neck massage unit of a conventional massage chair or in an independent massage device. However, one of disadvantages of the aforementioned construction is that it is only capable of producing a single kneading massage action, and does not have any other functions other than the massage action.

### SUMMARY OF THE INVENTION

A primary objective of the present invention is to provide a massage device that can apply pressing and kneading massage actions.

Another objective of the present invention is to provide a massage device with increased functionality, capable of providing heating and vivid light effects for offering an improved relaxing sensation to a user.

In order to achieve the objectives, a massage device according to the present invention includes a housing in which is assembled with an actuating mechanism comprised of a worm shaft and worm gears. The massage device also includes at least one massage unit mounted through the housing and driven by the actuating mechanism. The massage unit includes a driving gear and a plurality of driven gears engaged with the driving gear to form a set of planetary gears. A top of each driven gear is provided with a plurality of mounting seats of different heights, and a massage member is disposed on the each mounting seat. As multiple massage members are provided at different positions and heights, a massage action comprised of pressing and kneading movements can be produced on a region of a user's body when being put in contact with the massage members.

In addition, a plurality of heating element circuits may also be provided between the housing and the massage unit. The heating elements can include electrically heated wires, thermal resistors, ceramics heaters or filaments, lamps, etc. When the heating element circuits are activated, heat and/or light are irradiated through the massage members to provide a vivid light effect. The light effect improves the aesthetic appearance of the massage device, whereas the heating effect offers improved relaxing sensation.

In order to improve the massage effect, the massage members may also be provided with a material with curing characteristics, such as magnetite, germanium, titanium, nano-materials, ceramics or materials that can emits infrared rays.

The operation of the massage device is accomplished by a motor driving the movement of one or more massage unit. Owing to the set of planetary gears and design of the mounting seats of different heights, the massage members provide a massage action combining rotation and up and down pressure movements. Two or more different types of massage movements can be thereby achieved with a minimal amount of component parts. Furthermore, during massage, the heating elements emit heat to enhance blood circulation and relieve fatigue.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a massage device according to an embodiment of the present invention;

FIG. 2 is an exploded view showing the massage device according to the present invention;

FIG. 3 is a top view showing the massage device without the restricting covers, according to the present invention;

FIG. 4 is a cross-sectional view taken along line IV-IV of FIG. 3; and

FIG. 5 is a schematic view showing an operating state of the massage device according to the present invention.

### DETAILED DESCRIPTION OF THE PREFERRED EMBODIMENTS

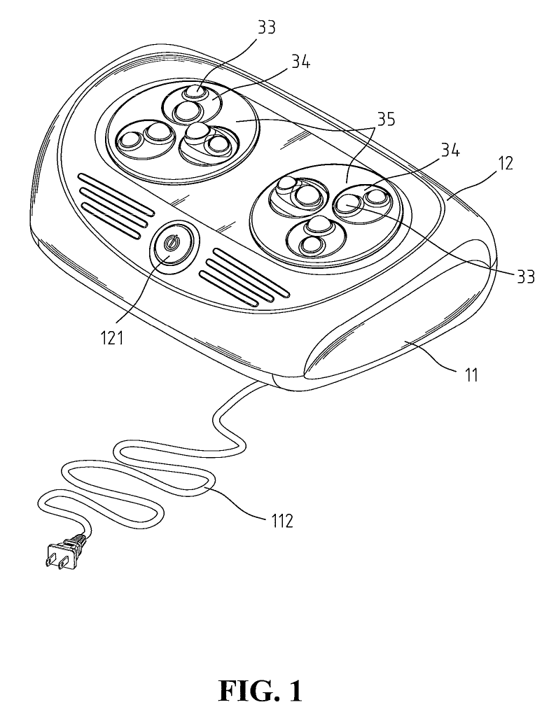

Referring to FIGS. 1-4, a massage device according to an embodiment of the present invention includes a lower casing 11 and an upper casing 12 that are assembled with each other to form an outer housing and define an accommodating space therebetween. The lower casing 11 is provided with a plurality of support brackets 111 for securing an actuating mechanism 2, and power supply parts, such as a power cord 112 or like electric components. The upper casing 12 includes a switch 121 electrically connected with the power cord 112. A surface of the upper casing 12 also includes a recessed portion 122 for placement of a massage unit 3. According to the embodiment, two recessed portions 122 are respectively provided for placement of two massage units 3. Each of the recessed portions 122 has at least one assembly hole 123 adapted for assembling the massage unit 3. The actuating mechanism 2 is covered under a cover 21, and includes a motor 22 and a worm shaft 23 coupled with a rotary axle of the motor 22. Both sides of the worm shaft 23 are symmetrically engaged with two worm gears 24. Each of the worm gears 24 respectively engages with an intermediary gear 25 that in turn engages with a transmission gear 26. A transmission axle 27 is respectively passed through and fixed with each of the transmission gears 26. Each of the transmission axles 27 passes through the cover 21 and the upper casing 12.

Each of the massage units 3 comprises a driving gear 31 and three driven gears 32 in engagement with the driving gear 31 for forming a set of planetary gears. A top of each driven gear 32 has two mounting seats 321 of different heights, each for placement of one massage member 33. The massage members 33 are not be limited to any specific structure. The structure of the massage members 33 includes, but not limited to, a raised shape with a curved surface or with non-uniformly angled surface portions (not shown). According to the embodiment, the massage members 33 are massage balls and made of a transparent material or a translucent material, such as glass. The massage members 33 may also be made of a different material, such as plastics, metal and ceramics. Sandalwood, Agilawood or wood having aroma may also be used to form the massage members 33. Such wood may have the advantage of dissipating aromatic scent or Phytoncide. Based on alternative medicine, the massage members 33 may be made of materials with curing characteristics, such as magnetite, germanium, titanium, nano-materials or materials that can emits infrared rays, to alleviate muscle pain and enhance blood circulation. The massage members 33 may also be made of a material containing the aforementioned ingredients. A user may desirably select or change the massage members 33 based on their different shapes or constituent materials. Moreover, each of the driving gear 31 and the driven gears 32 has an axis portion adapted to insert in each assembly hole 123. Each massage unit 3 also includes a plurality of restricting covers 34 that correspond to the driven gears 32 in amount. Each restricting cover 34 includes two restricting holes 341 corresponding to the massage members 33. After the restricting cover 34 is mounted on the driven gear 32, the massage members 33 are restrictedly mounted in the restricting holes 341, respectively. Moreover, the massage members 33 are slidably placed on the mounting seats 321. A lid 35 provided with three throughout holes 351 is mounted on each recessed portion 122. After the lid 35 is securely fixed on the recessed portion 122, each of the restricting covers 34 is correspondingly restricted in each the throughout hole 351. The restricting cover 34 is able to rotate relative to the lid 35. Therefore, the massage device is thereby assembled.

In addition, a plurality of heating element circuits 4 are also provided on the surface of the recessed portion 122 proximate to the driven gears 32. The heating elements can be electrically heated wires, thermally-dissipating resistors, thermal resistors, ceramics heaters or filaments, lamps, etc. The heating element circuits 4 according to the embodiment include lamp circuits. The heating element circuits 4 are electrically connected with the power supply, thereby providing heating capabilities to the massage device. A plurality of cushion elements 5, such as rubber, can also be mounted on a bottom of the lower casing 11 for reducing vibration produced during operation of the massage device.

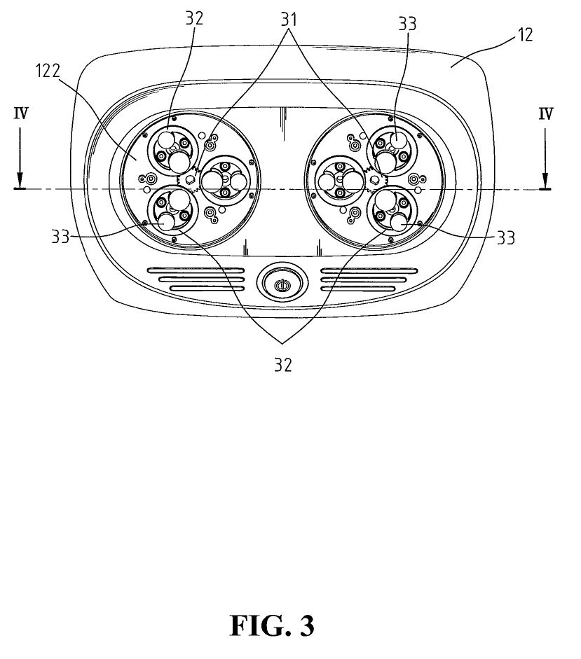

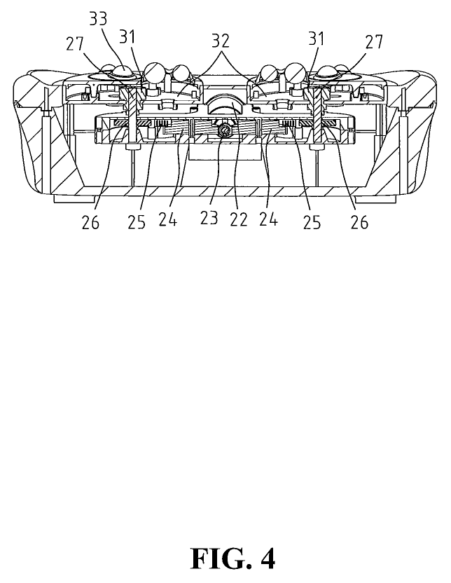

Referring to FIGS. 3 and 4, when the power cord 112 is connected, a user can power on the switch 121 to activate the operation of the massage device. Of course, the electric circuit coupled with the switch 121 can be designed for independently activating the massage and heating functions. In the present embodiment, these two functions are activated through a unitary circuit. In other words, when the switch 121 is turned on, the motor 22 and heating element circuits 4 can be activated at the same time. When the motor 22 is activated, the worm shaft 23 drives the two worm gears 24 to rotate and the worm gears 24 drive the intermediary gears 25 to rotate. The intermediary gears 25 in turn drive rotation of the transmission gears 26 and transmission axles 27. Driven by the transmission axles 27, the driving gears 31 drive the driven gears 32 located at its periphery. The restricting covers 34 mounted on the driven gears 32 rotate with the driven gears 32. Accordingly, the massage members 33 spin on themselves between the mounting seats 321 and the restricting covers 34. When viewed from the outside, the restricting covers 34 rotate relative to the lid 35. In addition, the activated lamps emit light that propagates through the massage members 33 and restricting covers 34, providing a vivid light effect to the massage device.

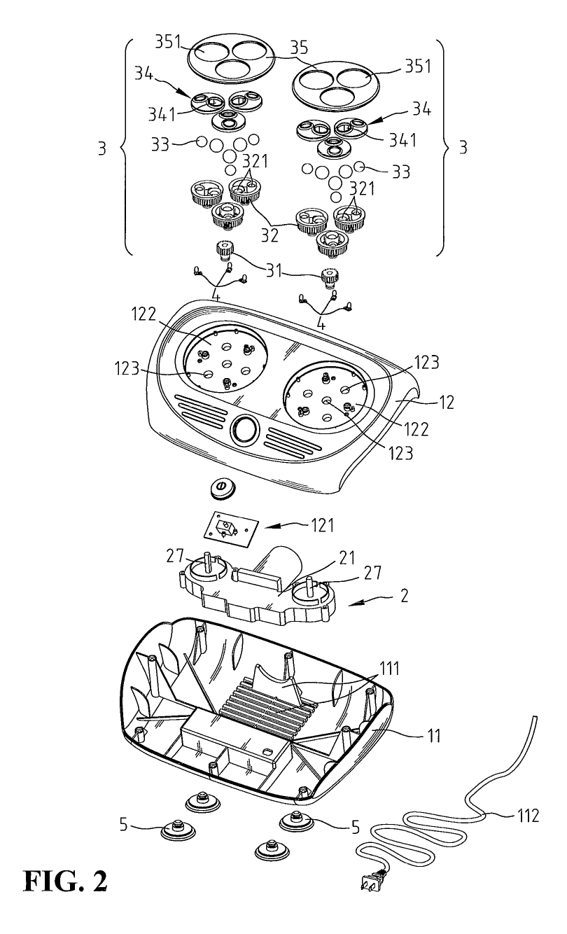

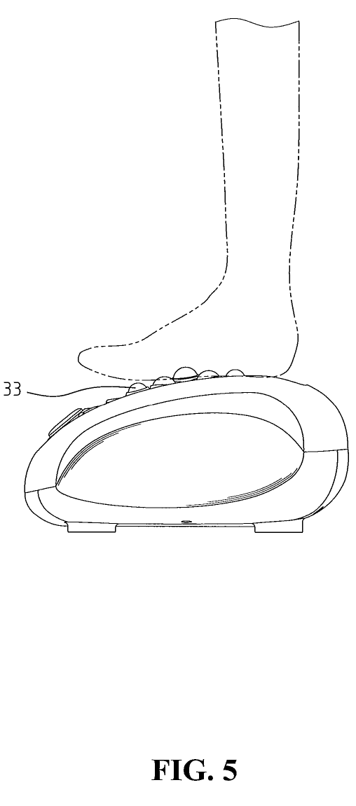

FIG. 5 is a schematic view showing an operation state of the massage device according to the embodiment of the present invention. Referring to FIGS. 2 and 5, the massage device according to the present invention may be adapted for, but not limited to, foot massage application. When both feet are put on the massage members 33 of the two massage units 3, multiples regions of the feet are in contact with the massage members 33. As the massage members 33 are driven in rotation owing to the movement of the driven gears 32, the difference in height of the mounting seats 321 also causes the massage members 33 to apply acupressure actions on the bottoms of the feet. In addition, the rotation of the driven gears 32 also causes the massage members 33 to spin on themselves, whereby a kneading massage action is also produced on the feet. While the massage action is applied, the lamps can produce heat that is applied through the massage members 33 on the feet. In case the massage members 33 are provided with a material with curing characteristics as described previously, the massage action combined with the alternative medicine can further enhance blood circulation.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A massage device, comprising:
an upper casing and a lower casing assembled together to form an accommodating space;
an actuating mechanism disposed in the accommodating space;
at least one massage unit disposed on the upper casing and driven by the actuating mechanism, wherein the massage unit comprises a driving gear and a plurality of driven gears engaged with the driving gear to form a set of planetary gears, a top of the each driven gear is provided with a plurality of mounting seats of different heights, and a massage member is slidably disposed on each of the mounting seats; and
a power supply comprising a switch and a power cord;
wherein the set of planetary gears and the massage members are driven in movement by the actuating mechanism, whereby a massage action is produced on a region of a user's body in contact with the massage members.

2. The massage device according to claim 1, wherein a restricting cover is disposed on each of the driven gears and is provided with a plurality of restricting holes corresponding to the mounting seats in number so as to enclose the massage member there between.

3. The massage device according to claim 2, wherein the massage unit comprises a lid secured on the upper casing, the lid comprises a plurality of throughout holes corresponding to the driven gears in number, each of the restricting covers is received in one of the throughout holes.

4. The massage device according to claim 1, wherein a plurality of heating element circuits are provided on the upper casing and proximate to the massage unit, the heating element circuits are electrically connected with the power supply.

5. The massage device according to claim 3, wherein a plurality of heating element circuits are provided on the upper casing and proximate to the massage unit, the heating element circuits are electrically connected with the power supply.

6. The massage device according to claim 1, wherein the actuating mechanism comprises a worm shaft and worm gears engaged with the worm shaft.

7. The massage device according to claim 1, wherein a bottom of the lower casing is provided with a plurality of cushion elements.

8. The massage device according to claim 1, wherein the massage member includes a material with curing characteristics.

9. The massage device according to claim 8, wherein the material with curing characteristics includes magnetite, germanium and titanium.

10. The massage device according to claim 4, wherein the heating element circuits includes a lamp circuit.
